(19) United States
(12) Patent Application Publication
(10) Pub. No.: US 2003/0187175 A1
(43) Pub. Date: Oct. 2, 2003

(54) Hydroxyl-containing fluorinated ooly (siloxane amideimide)

(75) Inventors: Jeng-Cheng Yang, Tao-Yuan (TW); Hon-Bin Chen, Tao-Yuan (TW); Te-Chuan Chang, Tao-Yuan (TW); Gaw-Pying Wang, Tao-Yuan (TW)

Correspondence Address: BACON & THOMAS, 625 Slaters Lane - 4th Floor, Alexandria, VA, 22314, US

(73) Assignee: Chung-Shan Institute of Science & Technology,, Tao-Yuan (TW)

(21) Appl. No.: 10/107,143

(22) Filed: Mar. 28, 2002

(51) Int. Cl. C08G 77/00

(52) U.S. Cl. 528/10

(57) ABSTRACT

A hydroxyl-containing fluorinated poly(siloxane amideimide) is composed mainly of a hydroxyl-containing fluorinated polyamideimide portion formed by the reaction of a fluorinated dianhydride and a hydroxyl-containing fluorinated diamine, and a flexible siloxane-containing fluorinated polyimide portion formed by the reaction of a fluorinated dianhydride and a siloxane diamine. Said hydroxyl-containing fluorinated poly(siloxane amideimide) can be used as a surface acoustics wave (SAW) coating.

### FIELD OF THE INVENTION

The present invention relates to a hydroxyl-containing fluorinated poly(siloxane amideimide), particularly a hydroxyl-containing fluorinated poly(siloxane amideimide) having an improved degree of imidization, better thermal oxidation stability, and a lower Tg.

### BACKGROUND OF THE INVENTION

U.S. Pat. No. 5,733,481 discloses a composition for use in the formation of an active light waveguide comprising a fluorinated polyamic acid and an electro-optical material. The active light waveguide is manufactured by subjecting the fluorinated polyamic acid to imide ring closure into a fluorinated polyimide, and orienting the electro-optical material. The active light waveguide fabricated by using the composition can provide excellent electro-optical effect. The active light waveguide is extremely thermal stable and suitable to manufacture of electro-optical devices.

U.S. Pat. No. 4,997,869 discloses an organic solution of polyimide suitable for producing an electric coating on a semiconductor wafer through a spin-coating process. Said polyimide is formed by the polycondensation of 4,4′-(hexafluoroisopylidene)diphthalic anhydride (hereinafter referred as 6FDA) and 2,2′-bis(3-amino-4-hydroxyphenyl)hexafluoropropane (hereinafter referred as AHHFP).

As mentioned in the previous two U.S. patents, fluorinated polyimides have improved properties, such as lower hydroscopicity, dielectric constant, and optical loss. However, a polymer with glassy and crystal regions usually exhibits a low vapor permeability, and is not suitable to be used as a surface acoustic wave (SAW) coating. Therefore, if its Tg can be further lowered, it will be more suitable to be used in the production of a SAW device. In addition to a lower Tg, said polymer must have a good solubility, and good and stable film formation properties.

### SUMMARY OF THE INVENTION

A primary objective of the present invention is to provide a hydroxyl-containing fluorinated poly(siloxane amideimide) having an improved degree of imidization, enhanced thermal oxidation stability, and a lower Tg. The hydroxyl-containing fluorinated poly(siloxane amideimide) synthesized according to the present invention comprises a structure shown by the following formula (I):

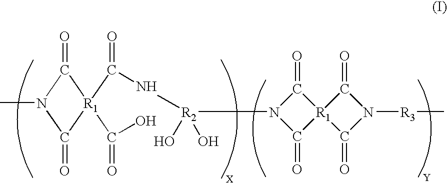

wherein

a ratio of X to Y is between 90:10 to 10:90, preferably 80:20 to 25:75;

R₁ is from a fluorinated dianhydride having a structure of

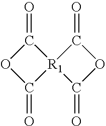

and R₁ comprises a fluoro-substituent;

R₂ is from a hydroxyl-containing diamine having a structure of

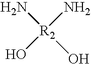

and R₂ comprises a fluoro-substituent; and

R₃ is

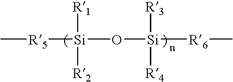

wherein R′₁, R′₂, R′₃ and R′₄ independently are C1-C4 alkyl or phenyl, R′₅ and R′₆ independently are C1-C6 alkylene or phenylene, and n=1˜10.

Preferably, R₁ is

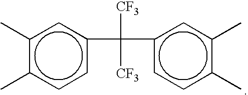

Preferably, R₂ is

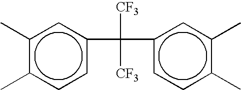

Preferably, R′₁, R′₂, R′₃ and R′₄ are methyl, R′₅ and R′₆ are propylene, and n=1.

### BRIEF DESCRIPTION OF THE DRAWINGS

FIG. 1 shows IR spectra of the samples of Control 1, Example 1-4, and Control 2; wherein the spectra A to F represent the samples of FPI, FPSI-20, FPSI-35, FPSI-50, FPSI-75 and FPSI-100 in Table 1, respectively.

FIG. 2 shows ¹³C-NMR spectra of the samples of Control 1, Example 1-4, and Control 2; wherein the spectra A to F represent the samples of FPI, FPSI-20, FPSI-35, FPSI-50, FPSI-75 and FPSI-100 in Table 1, respectively.

FIG. 3 shows Tg of the samples of Example 1-4 and Control 2 vs. the mole fraction of APrTMDS in the samples, respectively.

### DETAILED DESCRIPTION OF THE PRESENT INVENTION

A suitable process for preparing a hydroxyl-containing fluorinated poly(siloxane amideimide) of the present invention comprises the following steps:

a) undergoing a polycondensation reaction of Y moles of a siloxane diamine and (X+Y) moles of a fluorinated dianhydride, thereby forming a product mixture containing an anhydride-terminated polyamide;

b) adding X moles of a hydroxyl-containing diamine into the product mixture of Step (a) to undergo a polycondensation reaction; and

c) heating the resulting product mixture obtained from Step (b) so that a portion of polyamic acid therein is cyclized into a polyimide, thereby obtaining a hydroxyl-containing fluorinated poly(siloxane amideimide) comprising the structure of the formula (I).

Optionally, the siloxane diamine and the hydroxyl-containing diamine in Step (a) and Step (b) can be interchanged.

Optionally, Step (a) and Step (b) can be simplified into a single step. That is: X moles of a hydroxyl-containing diamine and Y moles of siloxane diamine simultaneously undergo a polycondensation reaction with (X+Y) moles of a fluorinated dianhydride.

Preferably, said polycondensation reactions are carried out in an organic solvent system selected from the group consisting of N-methyl-2-pyrrolidone (hereinafter referred as NMP), N,N-dimethylacetamide (hereinafter referred as DMAc), dimethylformamide (hereinafter referred as DMF), dimethylsulfoxide (hereinafter referred as DMSO), m-cresol, pyridine, chloromethane, chloroethane, toluene and a mixture thereof. More preferably, said polycondensation reactions are carried out in an organic mixture of DMAc and toluene in a volume ratio of 3:1.

Preferably, the ratio of X to Y is 90:10 to 10:90; more preferably, the ratio of X to Y is 80:20 to 75:25.

Preferably, the siloxane diamine in Step (a) is 1,3-bis(3-aminopropyl) tetramethyldisiloxane (hereinafter referred as APrTMDS).

Preferably, the hydroxyl-containing diamine in Step (b) is 2,2′-bis(3-amino-4-hydroxyphenyl)hexafluoropropane (hereinafter referred as AHHFP).

Preferably, the fluorinated dianhydride in Step (a) is 4,4′-(hexafluoroisopylidene)diphthalic anhydride (hereinafter referred as 6FDA) or 2,2-bis[4-(3,4-dicarboxyphenoxy) phenyl]hexafluoropropane dianhydride (hereinafter referred as 6FDEDA). More preferably, the former is used.

The present invention can be elaborated in greater detail by referring to the following examples which are for illustrative purposes only and not for limiting the scope of the present invention. The reactions involved in the following examples are shown in the following Scheme 1.

A fluorinated polyamideimide was synthesized by the conventional two-step process as shown in Scheme 1. According to the formula shown in Table 1, the reactants were dissolved in a mixed solvent of DMAc/toluene in a volume ratio of 3:1, thereby producing a fluorinated polyamideimide by a solution imidization. The polymerization reaction was carried out under a nitrogen atmosphere and in said mixted solvent (with a solid content of 15 wt %).

TABLE 1

| | 6FDA | AHHFP | APrTMDS | DMAc/toluene |
|---|---|---|---|---|
| Sample Code | (mole) | (mole) | (mole) | 3/1 (ml) |
| FPI | 0.020 | 0.020 | 0 | 91 |
| FPSI-20 | 0.020 | 0.016 | 0.004 | 88 |
| FPSI-35 | 0.020 | 0.013 | 0.007 | 86 |
| FPSI-50 | 0.020 | 0.010 | 0.010 | 84 |
| FPSI-75 | 0.020 | 0.005 | 0.015 | 80 |
| FPSI-100 | 0.020 | 0 | 0.020 | 76 |

Control 1:

0.02 mole of 6FDA was dissolved in 91 ml of a mixed solvent of DMAc/toluene [3/1 (v/v)]. To the solution 0.02 mole of AHHFP was added. At room temperature, said mixture was reacted under agitation for 24 hours. The resulting produce mixture was cast on a mold, and then heated at 160° C. for 24 hours. The film thus formed was ground into a powder, and dried in vacuo at 80° C. for 8 hours, thereby obtaining a brown solid hydroxyl-containing fluorinated polyamideimide (FPI).

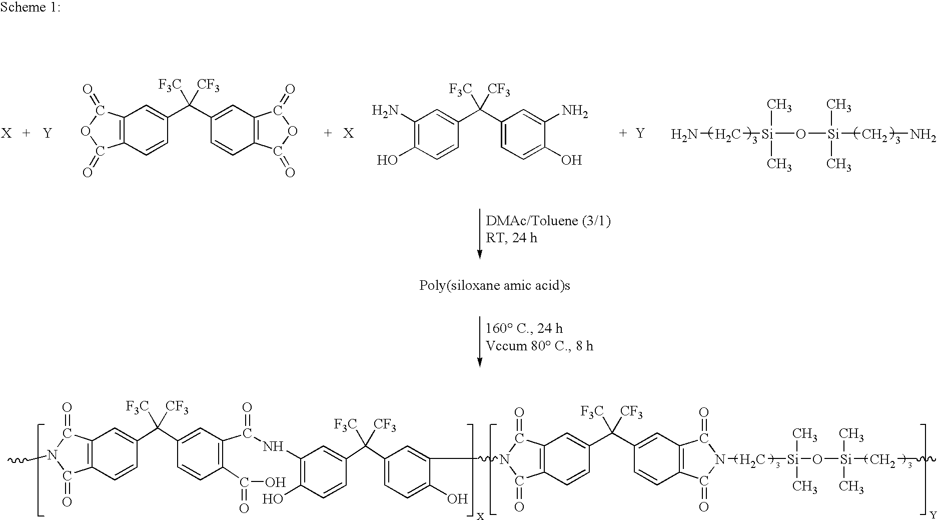

Control 2:

The procedures of Control 1 were repeated except that AHHFP was replaced by APrTMDS, thereby obtaining a hydroxyl-containing fluorinated poly(siloxane amideimide) (FPSI-100).

### EXAMPLES 1-4

Hydroxyl-containing fluorinated poly(siloxane amideimides) (FPSI-20, FPSI-35, FPSI-50 and FPSI-75) were prepared according to the formulas shown in Table 1. The synthesis of FPSI-50 is described as a representative example in the following: To a 6FDA (0.02 mole) solution in a mixed solvent of DMAc/toluene (DMAc:toluene=3:1 (v/v)) 0.01 mole of APrTMDS was slowly added. The terminal amino groups of the APrTMDS reacted with 6FDA, thereby forming a polyamic acid intermediate product having anhydride terminals in the solution. Next, 0.01 mole of AHHFP was gradually added to said intermediate product solution to perform a polycondensation reaction with the intermediate product and the residual 6FDA. Next, a hydroxyl-containing fluorinated poly(siloxane amideimide) (FPSI-50) was prepared by the procedures similar to those for producing FPI in Control 1. 50 in FPSI-50 denotes the mole % of APrTMDS, based on the mole sum of AHHFP and APrTMDS.

Infrared spectra of samples dispersed in dry KBr pellets were recorded between 4000 and 550 cm⁻¹ on a Bomen DA 3.002 FTIR spectrometer. The ²⁹Si- and ¹³C-nuclear magnetic resonance (NMR) spectra of the polyimides were determined (Bruker MSL-400) by using the cross-polarization combined with magic angle spinning (CP/MAS) technique. Proton spin-spin relaxation time (T₂) was measured at room temperature via solid state ¹³C NMR using the pulse sequence described by Tékély [P. Tékély, D. Canet and J. Delpuech (1989). J. Mol. Phys., 67, 81.] Differential scanning calorimetry (DSC) was conducted in a Perkin Elmer 7 unit. The characteristics and kinetics of degradation of fluorinated polyimides were measured by a Perkin-Elmer TGA-7 at heating rate of 10° C./min under air and nitrogen. The sample weight was about 10 mg, and the gas flow rate was kept at 100 mL/min.

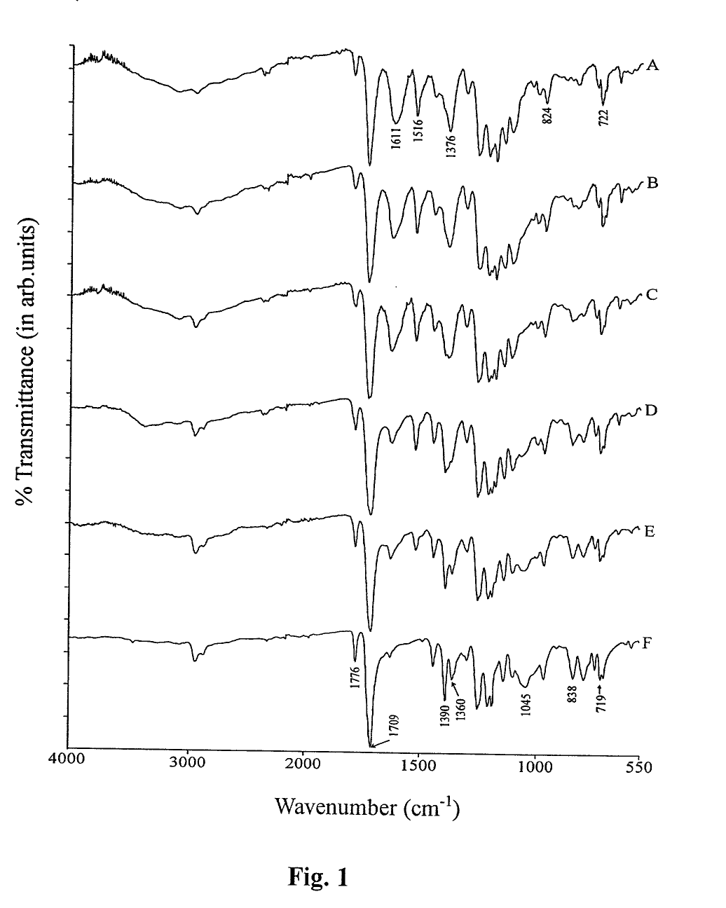

FIG. 1 showed the IR spectra of the polyamideimides prepared in Control 1-2 and Examples 1-4. The IR spectrum (spectrum A) of the FPI prepared in Control 1 exhibits the characteristic imide peaks at 1786 cm⁻¹ (symmetric stretching of imide C═O), 1722 cm⁻¹ (asymmetric stretching of imide C═O), 1376 cm⁻¹ (stretching of imide C-N) and 722 cm⁻¹ (deformation of imide ring). These characteristic absorption peaks of imide groups are also observed the spectra of FPSIs prepared in Examples 1-4 and Control 2 (spectra B to F). However, in the spectrums B to F, the intensities of the amide absorptions (1611 cm⁻¹ and 1516 cm⁻¹) and the hydroxyl group absorption (3400-3200 cm⁻¹) decrease along with increasing disiloxane content, whereas that of the Si—O—Si absorption (1045 cm⁻¹) increases. The above results reveal that the flexible APrTMDS enhances the degree of imidization.

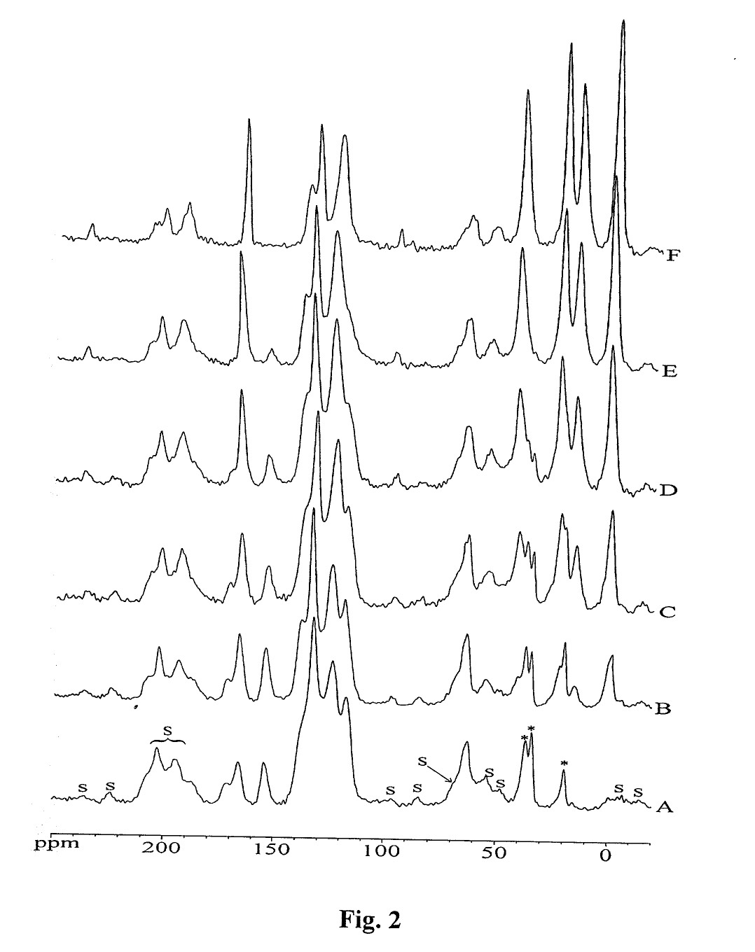

The ¹³C CP/MAS NMR spectra of polyimides prepared in Controls 1-2 and Examples 1-4 are shown in FIG. 2. A set of peak for FPI (FIG. 2A) prepared in Control 1 is observed at 166, 155, 140-118, and 64 arising from imide carbonyl, aryl carbons with hydroxyl groups, various aromatic carbons, and trifluoromethyl carbons, respectively. The ¹³C CP/MAS NMR spectra of hydroxyl-containing FPSIs [FIGS. 2 (B-E)] prepared in Examples 1-4 are nearly identical. The intensities of the peaks at 154 and 67 ppm decrease with increasing disiloxane content, whereas those at around 41, 22, 16 and 0 ppm increase. This latter set of chemical shifts is then due to APrTMDS segments, which correspond to —NCH₂—, —CH₂—, —CH₂Si—, and —SiCH₃, respectively. Therefore, ¹³C CP/MAS NMR spectrum of FPSI-100 (FIG. 2F) prepared in Control 2 shows only the characteristic peaks of imide carbonyl, various aromatic carbons, quartet carbons and APrTMDS segments. Notely, the resonances at 38, 35 and 20 ppm are solvent peaks (DMAc) and those decrease with increasing disiloxane content. The result implies that the interaction between hydroxyl-containing fluorinated imide segments with DMAc is decreased. Therefore, the APrTMDS can modify the acidity of the FPI polymer. On the other hand, the chemical shifts of ²⁹Si CP/MAS NMR spectra for FPSIs are around 8 ppm, and the peak widths (˜700 Hz) are independent of the APrTMDS content. It suggests that the silicons in FPSIs have similar electronic environment.

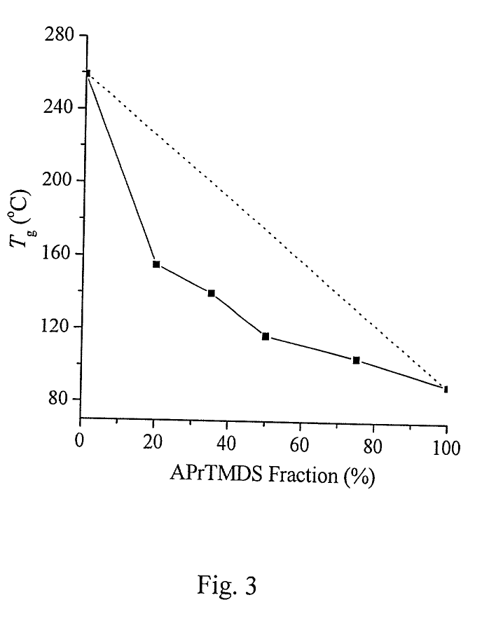

The FPI prepared in Control 1 has a glass transition temperature (T_{g}) of 259° C. However, the values of T_{g} of FPSIs prepared in Examples 1-4 decrease with the enhancement of APrTMDS to around 90° C. (FIG. 3). Apparently with the addition of the flexible APrTMDS as a segment in polyimide structure, a lowering of T_{g} is expected. However, the lower concave from the T_{g} diagram for miscible blends implies that the intermolecular interaction, such as hydrogen bonding, reduced as APrTMDS is added. Therefore, the gas diffusion in the FPSI could be increase as APrTMDS is incorporated into polyimides.

Thermal stability of the FPI of Control 1, the FPSIs of Examples 1-4 and the FPSI-100 of Control 2 were evaluated from TGA in air and nitrogen, and the results show that the thermal oxidation stability of FPSIs is enhanced along with the inclusion of APrTMDS into the FPI.

What is claimed is:

1. A hydroxyl-containing fluorinated poly(siloxane amideimide) comprising a structure represented by the following formula: 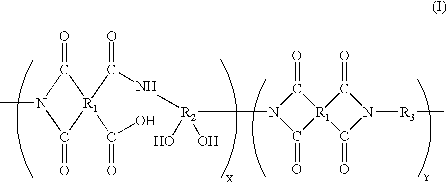
wherein
a ratio of X to Y is 90:10 to 10:90;
R₁ is from a fluorinated dianhydride having the structure 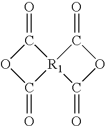
and R₁ comprises a fluoro substituent;
R₂ is from a hydroxyl-containing diamine having the structure 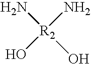
and R₂ comprises a fluoro substituent; and
R₃ is 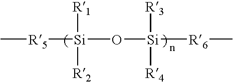
wherein R′₁, R′₂, R′₃ and R′₄ independently are C1-C4 alkyl or phenyl, R′₅ and R′₆ independently are C1-C6 alkylene or phenylene, and n=1˜10.

2. The hydroxyl-containing fluorinated poly(siloxane amideimide) as claimed in claim 1, wherein
R₁ is

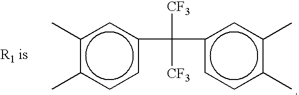

3. The hydroxyl-containing fluorinated poly(siloxane amideimide) as claimed in claim 1, wherein
R₂

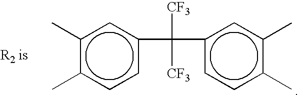

4. The hydroxyl-containing fluorinated poly(siloxane amideimide) as claimed in claim 2, wherein
R₂ is

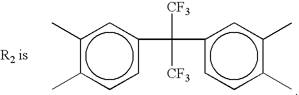

5. The hydroxyl-containing fluorinated poly(siloxane amideimide) as claimed in claim 3, wherein R′₁, R′₂, R′₃ and R′₄ are methyl, R′₅ and R′₆ are propylene, and n=1.

6. The hydroxyl-containing fluorinated poly(siloxane amideimide) as claimed in claim 4, wherein R′₁, R′₂, R′₃ and R′₄ are methyl, R′₅ and R′₆ are propylene, and n=1.

7. The hydroxyl-containing fluorinated poly(siloxane amideimide) as claimed in claim 1, wherein the ratio of X to Y is 80:20 to 75:25.
